(19) United States
(12) Patent Application Publication
(10) Pub. No.: US 2006/0245305 A1
(43) Pub. Date: Nov. 2, 2006

(54) System comprising sound reproduction means and ear microphones

(76) Inventors: Ronaldus Maria Aarts, EINDHOVEN (NL); Daniel Willem Elisabeth Schobben, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/551,968

(22) PCT Filed: Apr. 2, 2004
(86) PCT No.: PCT/IB04/50384

§ 371 Date: Oct. 5, 2005

(30) Foreign Application Priority Data
Apr. 11, 2003 (EP) 03100981.4

(51) Int. Cl. H04B 1/20

(52) U.S. Cl. 369/1

(57) ABSTRACT

A sound recording and reproduction system comprises ear microphones for recording sound and sound reproduction means for generating sound and means to control the sound signal generated by said sound reproduction means. The system comprises storing device (2) for storing sound signals recorded by the microphones (M_R,M_L), and an input (24) for reproduction of a recorded sound signal (S3) on the means for generating sound (LS_R,LS_L) through an adaptive filter (21). The system comprising a feed back system (25) comprising the input (24), the adaptive filter (21), at least an ear microphone (M_R,M_L), at least one sound reproduction means (LS_R,LS_L) and a comparison means (22) for comparing an input signal (S3) to a signal received by the microphone (S6) upon during reproduction of said input signal (S3), said comparison means (22) providing a comparison signal (e) for regulating the adaptive filter (21).

The invention relates to a sound recording and reproduction system comprising ear microphones for recording sound and sound reproduction means for generating sound and means to control the sound signal generated by said sound reproduction means.

Sound reproduction means are used in and for audio equipment such as (mobile) CD-players and comprise e.g. headphones.

Ear microphones are within the concept of the invention to be interpreted as microphones for use in or close to the ear or ears of a person.

The sound reproduction means, e.g. headphones, comprise a means for generating sound (usually a small loudspeaker). A recorded sound signal (voice or music) is sent to the headphone(s) and sound generators inside the headphone generate a sound. The listener will, however, perceive the generated sound as being generated inside or very near the head or more in general at the position of the sound reproduction means (where in fact it is generated) unless the sound signal is adapted. An unadapted sound is perceived to be unnatural. It is known to overcome such objections at least partially by recording the sound by means of a microphone in the ears using so called binaural recording. Although binaural recording improves the perception of sound, problems remain. An important aspect in this respect is the transfer characteristics of sound by an external source to the head and pinnae itself, the so-called Head Related Transfer Function (HRTF), i.e. the manner in which sound becomes attenuated and altered by the head and pinnea itself before it actually is heard.

Using binaural recordings a ‘standard head’ is usually used. The HRTF's are dependent on the actual shape and form of the head and the ear and differ substantially from one person to another. Furthermore, depending on the position of the microphones, the recorded sound, while being played back through the headphones, has travelled twice through the ear canal or has been influenced twice by the pinnae, which makes the sound reproduction sound not the same as during the recording. Furthermore the transfer function of the headphone itself has a detrimental influence on sound production. Although there has been made use of equalizers to lessen these detrimental effects such equalizing means only partially overcome the problems. An example of such a system is schematically shown in Blauert, The Psychophysics of Human sound, 1983, MIT Press pages 50-51.

It is an object of the invention to provide a sound system as described in the opening paragraph with improved sound reproduction.

To this end the system is characterized in that the system comprises a storing device for storing sound signals recorded by the microphones, and an input for a recorded signal for reproduction of the recorded sound signal on the headphone through an adaptive filter, the system comprising a feed back system comprising the input, the adaptive filter, at least one ear microphone and a comparison means for comparing an input signal from the storing device to a signal received by the microphone during reproduction of said input signal, said comparison means providing a comparison signal for regulating the adaptive filter.

In a system in accordance with the invention the detrimental effects of variations in transfer function are eliminated or at least reduced. The device comprises comparison means from comparing an input signal to the signal on the earphone. This enables the signal recorded by the microphone to be compared during play back to the originally recorded signal. The recorded signal can on the one hand (as an input signal) be sent to the loudspeaker of the headphone through an adaptive filter, on the other hand the recorded signal (as an output signal) can be compared to the signal received from the ear microphone giving a comparison signal, being the difference between the input and output. The adaptive filter is regulated with the comparison signal such that the comparison signal is minimized. Ideally the comparison signal is made zero, in which circumstances the sound signal at the position of the microphone during reproduction is exactly the same as the original signal. The feed back loop via the comparison means and the adaptive filter and the fact that the microphone is used for recording as well as during play back eliminates many of the shortcomings of the known systems.

An advantage of the system is also that it is independent of the microphone transfer function.

Preferably the system comprises a delay for delaying the recorded signal prior to the comparison means.

It takes some time for a signal to pass the adaptive filter, the sound reproduction means (e.g. a headphone) and the ear microphone. Using a delay for the input signal before comparing it to the signal as recorded by the microphone during play back improves the system.

Preferably the system comprises a means to alter the input signal prior to the comparison.

These and other objects of the invention will be apparent from and elucidated with reference to the embodiments described hereinafter.

In the drawings:

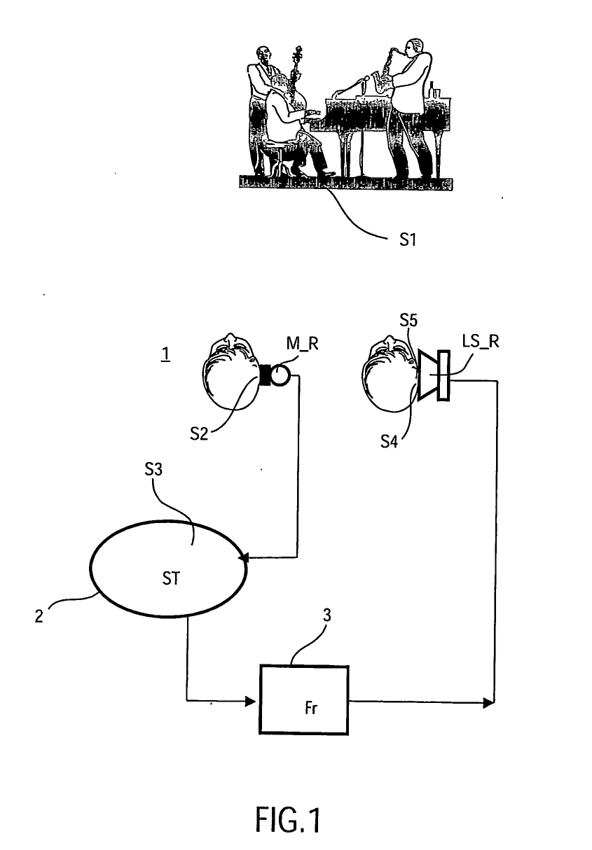

FIG. 1 illustrates schematically a system as known

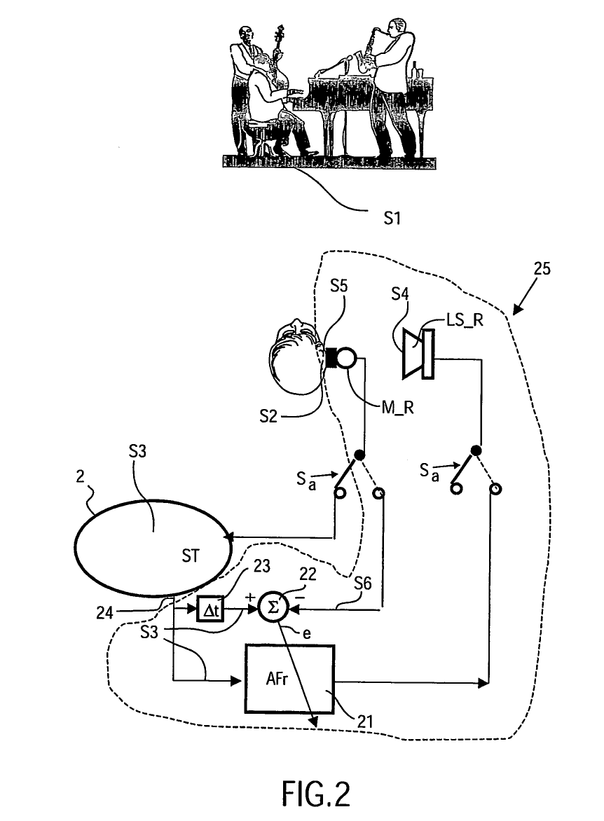

FIG. 2 illustrates schematically a system in accordance with the invention.

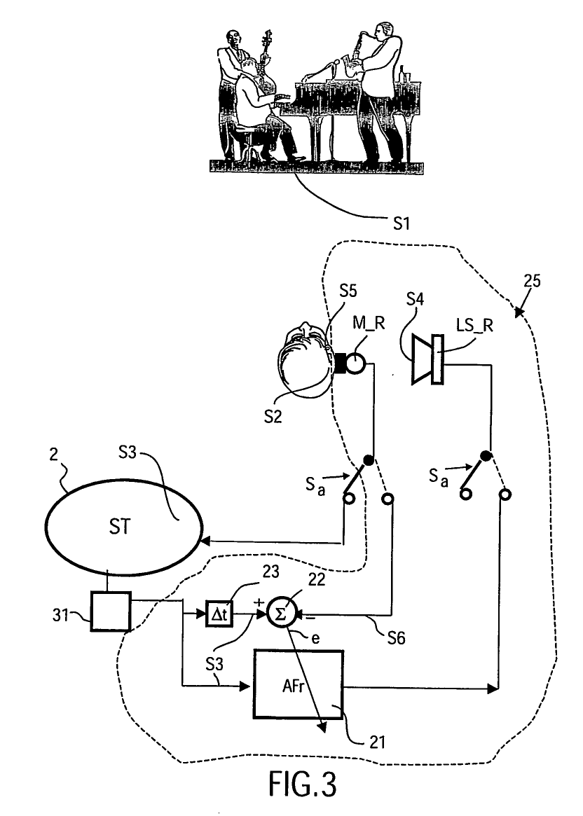

FIG. 3 illustrates schematically a further embodiment of a system in accordance with the invention.

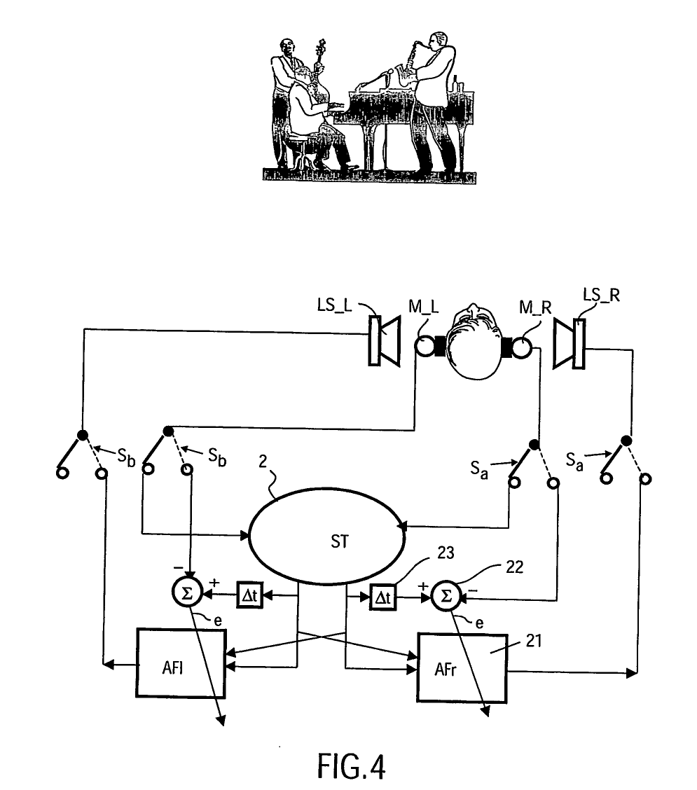

FIG. 4 illustrates schematically yet a further embodiment of a system in accordance with the invention.

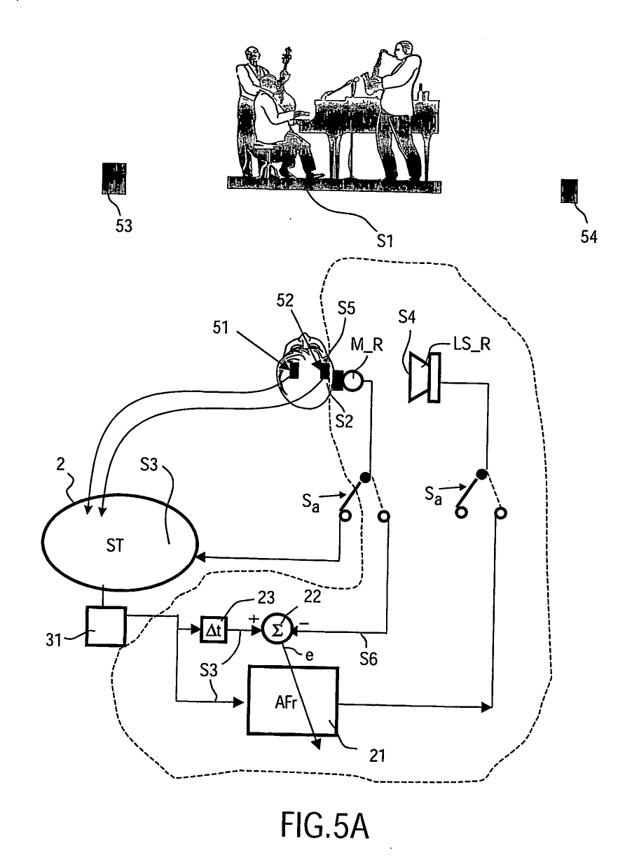

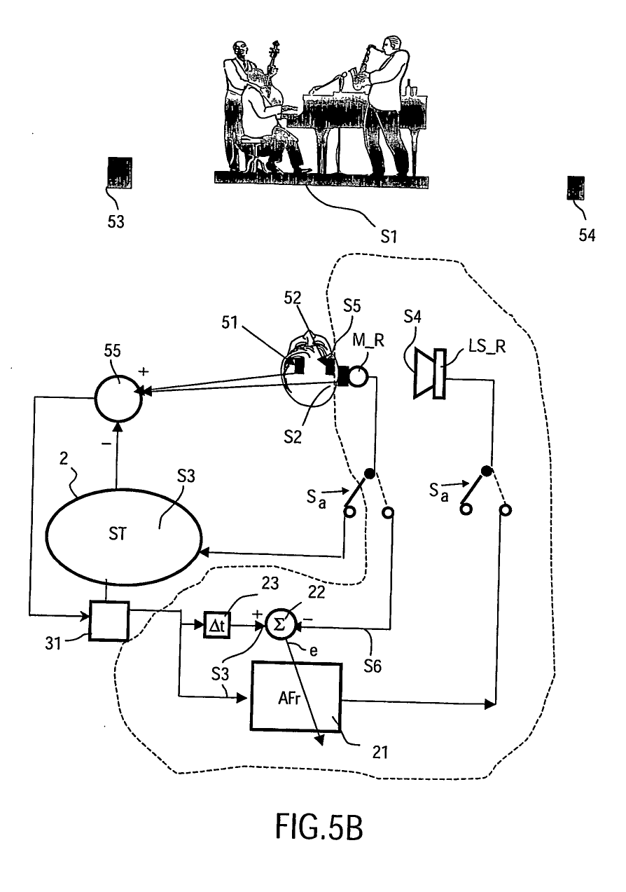

FIGS. 5A and 5B illustrate schematically yet further embodiments of a system in accordance with the invention in which head tracking means are incorporated.

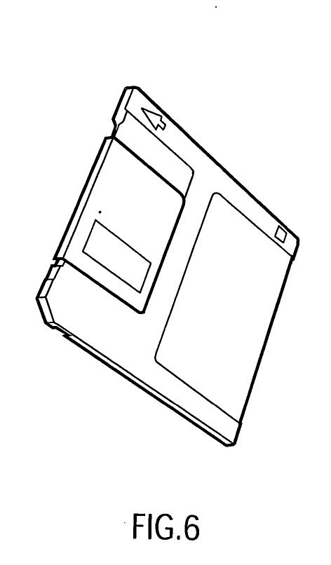

FIG. 6 illustrates a carrier for a computer program or computer program code for use in a system in accordance with the invention.

The figures are schematic and not drawn on scale.

FIG. 1 shows schematically a system as known. The head of a dummy or a person 1 has a microphone near an ear. An orchestra performs a piece of music.

For simplicity the original piece of music is denoted by signal S1. A recorded signal S2 is derived form the signal S1 and can be written as (in a somewhat simplified form)
S2=S1*transfer function orchestra-head*head related transfer function during recording.

There where in this application “transfer function” is written, the relation between one sound signal and another sound signal or one set of data and another set of data is meant. This may be a relatively simple function, but may also comprise complex matrix multiplication of data using several matrices.

The orchestra is playing some distance from the head, in a surrounding e.g. an orchestra hall and this modifies the signal S1. This is denoted by “transfer function orchestra-head”. This transfer function is independent of the shape or form of the head or of the ear shell or ear canal. The second transfer function, the head related transfer function is dependent, as is clear from the name, from the head, i.e. from e.g. the shape and size of the head, the ear shell, the ear canal.

This signal S2 is the signal at the microphone, This signal is recorded by the microphone to record a signal S3 in a storing device 2 (tape, CD etc). The signal recorded is S3. The microphone itself also influences the stored signal S3 which is denoted by the transfer function microphone and thus:
S3=S2*transfer function microphone.

This is the stored signal S3. In standard binaural recordings a dummy head is often used, especially when the microphone is located in the ear canal. Is such recordings the ‘head related transfer function” is thus the transfer function of the dummy head. When the signal is played back and directly fed to the headphones on a person, the signal S3 is played back through the headphones to give a signal S4. The signal S3 thus forms an input signal.
S4=S3*transfer function headphone

Finally this signal S4 is registered at the ear as a signal S5
S5=S4*head related transfer function during play back.

Note that head related transfer functions are often also dependent on the relative positions of source(s) and head thus the head related transfer function during recording and during play back may not be the same.

The head related transfer functions are dependent on the head thus differ in reality from head to head. In many known systems the data is acquired using a dummy head.

Overseeing the total recording and the playback cycle the relation between S1 (the signal from the orchestra) and S5 (the received signal after recoding and play back) may be written as
S5=S1*transfer function orchestra-head*head related transfer function during recording(for a dummy head)*microphone transfer function*transfer function headphone*head related transfer function during play back(for the person wearing the headphone).

In order to give a true rendition of the actual sound heard, this signal S5 should be the same as the signal S2 as would be received by the person wearing the headphones, which without some kind of filter would not be the case. Known devices use an equalizing filter 3 to try to accomplish this. The filter 3 basically multiplies the input signal S3 with a filter transfer function Fr.
S5=S1*transfer function orchestra-head*head related transfer function during recording*microphone transfer function*filter transfer function(Fr)*transfer function headphone*head related transfer function during play back

Ideally the filter transfer function Fr equals (microphone transfer function*transfer function headphone*head related transfer function during play back)⁻¹, i.e. the inverse of the multiplication of the microphone transfer function, the transfer function of the headphone and the head related transfer function during play back) giving:
S5=S1*transfer function orchestra-head*head related transfer function during recording*microphone transfer function*(microphone transfer function*transfer function headphone*head related transfer function)⁻¹*transfer function headphone*head related transfer function during play back=S1*transfer function orchestra-head*head related transfer function during recording=S2.

When a dummy head is used for recordings the transfer function of the filter would ideally also take into account the difference between the head transfer function of the dummy head during recording and the transfer function of the real head during play back. The transfer functions to be used by the filter 3 can, however, only be estimated or theoretically derived. The transfer function needs to be calculated and the calculation introduces errors. For each frequency the transfer function has to be determined, which either requires a large calculation effort and such calculation in itself may be a source of error or necessitates the use of average transfer functions for a band of frequencies, which also introduces errors. All transfer functions are also to some extent dependent not just on the relative positions of the sound sources (real or phantom) and the ears, but also on other factors, such as objects near the sources or ears which may reflect or alter the sound waves and thus influence the transfer functions.

Especially for the higher frequencies, the transfer functions are difficult to determine because of the shape of the head and the ear canal and differ from person to person and even may be dependent on factors such as wearing a hat. In short the Head Related Transfer function, HRTF, is a highly individual one. Even relatively simple transfer functions such as the microphone transfer function and the transfer function for the headphone have to be calculated and are sometimes more complex than one would think.

The filter 3 has in the known systems a fixed filtering function which can only be some average filtering function incapable, even if there would be no problems with calculating the transfer function (which there are), of taking into account influences which are from the outset unknown, such as the shape and size of the head, the ear canal, temperature, whether or not the user is wearing a hat etc.

In short in the known systems any transfer function needs to be calculated and the calculation introduces errors, for each frequency the transfer functions have to be determined, which either requires a large calculation effort and such calculation in itself may be a source of error or necessitates the use of average transfer functions for a band of frequencies, which also introduces errors and all transfer functions are to some extent dependent also on other factors, such as objects near the sources or ears which may reflect or alter the sound waves and thus influence the transfer functions and temperature. No fixed transfer function can take into account such dependence nor can it take into account difference between transfer functions for different heads.

Thus, using the known system a true-to-life like reproduction is difficult to attain and there is a need to improve the sound reproduction. A person will never hear what he has heard during a concert (or soccer match or anywhere where he/she was). Truly reliving the experience is therefore difficult, if not impossible. It is remarked that many systems offer the possibility to “improve” the sound quality, or even automatically improve the sound quality. To bring back the memories a true-to-life play back or at least a close to true-to-life play back is needed. It is an object of the invention to provide for a system which provides the possibility for an improved true-to-life play reproduction of the sound. The aim of the invention is to provide a system which does enable a more true-to-life rendition.

FIG. 2 illustrates a preferred embodiment of a system in accordance with the invention, shown in this figure for the right ear only.

The system comprises one or more microphones M_R in or near the ear. This microphone registers the sound and via the microphone a record is made on a storing device 2 (in this figure also denoted by ST). During recording the switch Sₐ is set such that the signals are sent to the recording device 2 (indicated by the drawn line in switch Sₐ). During playback the switches are changed, indicated by the dotted lines in the switches and the signal S3 from the storing device 2 is fed to a sound generating system, in this example a headphone LS_R via an adaptive filter 21. The signal S3 thus forms an input signal for a feed-back system 25 indicated by the elements within the dotted lines. Via input means 24 this input signal is fed to the feed-back system. The microphone is more or less at the same position as during recording and registers the sound S5 received as the music is played back. In a comparator 22 the signal S6 received and transmitted via the microphone (S6 equals S5*transfer function microphone) is compared to the stored signal S3, and the result of this comparison, an error signal “e” is used to regulate the adaptive filter function AFr of an adaptive filter 21. The feed back system 25 enables the input signal S3 (at the input 24) and the received signal S6 to be made substantially the same, the difference of the signals S6 and S3 (S6-S3) substantially equaling zero.

This leads to the following set of equations:
S3=S1*transfer function orchestra-head*head related transfer function during recording*microphone transfer
(as in the prior art)
S5=S1*transfer function orchestra-head*head related transfer function during recording*microphone transfer function*adaptive filter 21 transfer function AFr*transfer function headphone*head related transfer function during play back
and (as a result of the use of the microphone during play back and of the comparator 22)
S6=S5*microphone transfer function(signal via microphone during play back) S6=S3(both sides of the comparator 22)
This gives
S6=S3*microphone transfer function*adaptive filter 21 transfer function*transfer function headphone*head related transfer function during play back and
S6=S3
giving:
microphone transfer function*filter transfer function*transfer function headphone*head related transfer function during play back=1
giving:
AFr=filter transfer function of adaptive filter 21=(microphone transfer function*transfer function headphone*head related transfer function during play back)⁻¹

This may seem the same result as in the known device of FIG. 1, but for important differences, e.g. the microphone transfer function in signal S3 is per definition the same as the microphone transfer function in signal S6, without the need to calculate or estimate the microphone transfer function. This reduces errors. The head transfer functions are real personalized head transfer functions, not those from dummy heads, again taking away or at least reducing another source of errors. No estimations or calculations with their inherent errors are needed. Overall a much more life-like rendition of sound, i.e. the same as originally will be attained. In short the system comprises a storing device 2 for storing the sound signals S3 as recorded by the microphone, and a means for reproducing the recorded sound signal on the headphone through an adaptive filter 21, and a means 22 for comparing the stored signal S3 to a signal received by the microphone upon during reproduction S6, said comparison means providing in operation a comparison signal e for adaptively regulating the signal send to the headphone.

It is to be noted that the function of the feedback system is such as to set the settings of the adaptive filter 21 such that the signals at both sides of the comparator 22 are equal (S3=S6, i.e. e=0). This is independent of the nature of the input signal S3 on input 24 of the feed back system. In a preferred embodiment of the device in accordance with the invention use of this circumstance is made. When the listener activates the sound reproduction means a gauge signal (e.g. white noise) is briefly used as the input signal on input 24 (this signal does not necessarily have to have been recorded beforehand by the microphone(s)). Prima facie this seems superfluous and only bothersome, however, it enables to find gauge values for the filter characteristics AFr in a fast and efficient manner. The advantage is that when thereafter recorded music is played, the settings of the filter AFr are good or nearly good, so that no or only little changes to these settings have to be made. It has to be remembered that some music parts may have only low frequency sounds or certain frequencies do not appear than after some time, so at least during the initial stages of listening to the recorded music the adaptive filter is still adapting. Using a gauge signal it is possible to find the settings for the complete frequency range very rapidly. In preferred embodiments the settings for a person, once found, may be stored, so that the next times the same person uses the system, the starting values of that person are used to find the correct values, reducing time needed for the gauging procedure.

Preferably the system comprising a delay element or delayer 23 to delay signal S3 a time Δt before it is compared to signal S6. In the system it takes some time for signal S3 to travel through the adaptive filter, via the headphone (S4) and the microphone (S5) back to the comparator (S6). Using a delayer this time delay can be taken into account. It is remarked that the comparator and the adaptive filter may be some physical circuit, in which case the delay is formed by e.g. a sub-circuit. However, all or some of these functions may be done in soft-ware, i.e. using a computer program, for instance a delay of time Δt can be implemented by comparing the data of the signal S6 with stored data, i.e. using a pointer.

The equation would then be, t_{playback} being real time, i.e. the time at which the signal S6 is recorded:
S6(t_{playback})=S3(t_{playback}−Δt) (if error e=0)

Or in other words the recorded signals S6 are compared, using some computer program or program code, with stored data S3 of some time in the past and the filter functions are such adapted that the error e is substantially zero.

Likewise the filter function can be some filter circuit with inputs, but can and often will be formed in software, i.e. a computer program or computer program code performing the function of a filter having input data S3, input data for regulating (i.e. setting the adaptive filter) coming from the comparison, and output data to be sent to the headphone. Especially when using digital recording and sound reproduction use of computer programs or computer program code will be made. Within the concept of the invention some of these functions may be embodied in hard ware while others may be embodied in software. Within the concept of the invention the words “filter” “means for filtering” and “comparator” “means for comparing”, “delay” etc. are to be broadly understood and to comprise e.g. any piece of hard-ware (such filter circuit or filter, comparator, delay line), any circuit or sub-circuit designed for performing a filtering action, delay action, comparison as described as well as any piece of soft-ware (computer program or sub program or set of computer programs, or program code(s)) designed or programmed to perform a filtering, delaying, comparing operation in accordance with the invention as well as any combination of pieces of hardware and software acting as such, alone or in combination, without being restricted to the given exemplary embodiments.

The invention is also embodied in any computer program comprising program code means for use in a system in accordance with the invention when said program is run on a computer as well as in any computer program product comprising program code means stored on a computer readable medium for use in a system in accordance with the invention when said program is run on a computer and as well as any computer readable medium (CD-Rom, cassette or other carrier) comprising such computer program code means or computer program product.

FIG. 3 illustrates an embodiment of the invention.

The system has been provided with a setting device 31. Using this setting device the user may alter the signal data S3 before the comparator 22 and filter 21. Prima facie this may seem to offer a contradiction. The object of the system is to provide a true-to-life reproduction, using an adaptive filter 21. It would seem that changing the signal using the setting device would lead away from this object.

However the object of the invention is to provide a system offering the possibility for a true-to-life reproduction, not necessarily forcing the user to only a true-to-life reproduction. Offering the possibility to change the data using the setting device 31 is not contradictory to this object, but only offers extra possibilities. The user might want to change the settings. He/she would then possibly hear something else than he/she had heard originally, for instance louder, but if the user wants to hear what was recorded louder, the preferred embodiment allows this.

The first function which could be set is the volume of the sound enabling the user to hear more the music more loudly.

A further function which may be set is the distribution between tones (for instance emphasizing the higher frequencies more).

In fact, the setting device enables in circumstances, a more true-to-life experience by the listener than without the use of a setting device.

As people age, the sensitivity of the ear itself changes, basically it becomes less sensitive and the sensitivity for higher frequencies become less. Similar effects occur due to a common cold or due to fatigue. The same sound at the ear is then perceived differently. Ideally, however, the listener will perceive the same sound. To some extent these effects can be counteracted by turning up the volume and changing the distribution over the frequencies, thus offering the possibility to come closer to the experience the listener once had even though the hearing has become less. Of course the decline in hearing can only be partially counteracted, but nevertheless the setting device 31 can be useful in enabling to come closer to the goal of reliving the experience.

All examples given so far show one ear only. FIG. 4 show an arrangement for two ears. The system is of course a double rendition of the system shown in FIGS. 2 and 3, but there is in addition a further preferred characteristic. To take into account cross talk between the left and right ear, the left ear signal is send to the right ear adaptive filter and vice versa.

It will be clear that within the framework of the invention many variations are possible. It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

Further variations may for instance be formed by: In addition to sound recorded by the microphones near or in the ear, also other things can be recorded on the storing device 2, e.g. power point files or representations, video's or web camera's parameters describing the set-up during the recording, the head movements (which may e.g. be measured by a head-tracker) during a recording can be recorded. In the latter case a compensation during the reproduction can be derived.

The recorded data can be encoded. Other parameters, like the bone conduction of a speaker can be recorded, enabling to reproduce the sound of a speaker how he actually perceives his own voice, “Storing device” should be interpreted broadly, e.g. the data can be transmitted or even broadcasted or the storing device could be a recording device enabling the data to be stored on a disk for later replay. The data is stored or recorded somewhere on some data carrier for play back. The data itself however, need not be stored in the system itself, but on some data carrier which is removable from the system itself. So a storing device is a unit for storing the data whether it is stored inside the system itself (on a hard disk for instance) or on a removable carrier (a CD-Rom for instance) or broadcasted or transmitted to some device outside the system itself for storing by such a device. So, within the concept of the invention the term storing device(s) comprise devices for sending data as they are recorded via some sort of transmission (IR transmission, cable, internet etc) to a data storage device. The storage device (i.e. were the recorded data are kept) itself may be part of but may also be remote form the system in accordance with the invention. In such cases the system in accordance with the invention would comprise a communication device for sending recorded data to a remote storage device (in itself not part necessarily part of the system), said communication device forming the storing device, since its function is to send recorded data to a storage device for storing, thus to store (to put into storage) the recorded data.

If during recording head movements are made which will not be made during play back, then the influences of these movements on the signal can be made undone, or the other way around, if there are head movements during play back mode, which were not made during the recording stage, the signals can be altered in such a way that it corresponds with the movements. Thus in preferred embodiments the system comprises means for recording head movements. FIG. 5A illustrates such an embodiment. The system comprises a system for recording head movements. In this example the system comprises a number of fixed points 53, 54 and a number of devices 51, 52 on the head. Sending a signal (e.g. an IR signal) from the head to the fixed point or vice versa, it is possible to establish the orientation of the head in respect of the fixed points. Assuming that in this example the receivers are located on the head, the signals of the receivers 51, 52 are fed into the storing device 2, thus recording the position and orientation of the head vis-à-vis the fixed points are thereby the head movements. The head position signals are stored. Upon replay the head position may be compared to the head position during play-back and this may be used as an input to a altering device 31 to alter the data so that account can be taken of the head movements, during recording, during play back and/or of differences in head position. This is schematically indicated in FIG. 5B where a comparison is made in comparator 55 between signal coming from the head tracking devices during playback with stored data from storing device 2. This difference is an input in device 31 which in this example comprises a delay and filter to correct for the position of the head during play back in relation to that during recording. Making use of sources and receivers enables a good tracking of the head movements. However, especially during recording such an elaborate system may not always be available. In such case use may nevertheless be made of head tracking devices to track head movements without using a system of sources and receivers. The position of the head in respect of the vertical axis may for instance be relatively accurately and easily be measured using tilt sensors, which generate a signal corresponding to an angle to the vertical axis. Movement sensors may be used to track movements in other directions. The head tracking device(s) may comprise or be comprised of video camera's. By analyzing video data head movements may be (re)constructed. It is remarked that in embodiments of the system in accordance with the invention the system may comprise video cameras (or a video camera) for simultaneous recording of video data, even if the video cameras do not function as a head tracking device. The necessary storage for the adaptive filter can be implemented by the storage device ‘ST’ as well. Since, all necessary data occurring in the FIR filter for the adaptive filter is available in ‘ST’ already. With the use of pointers this can easily be realized.

In simple set-ups the system will have one ear microphone per ear, however this is not a restriction. In more complex, preferred embodiments more than one, i.e. a system of microphones made by used for each ear. The microphone registers the sound at the position of the microphone. What is actually heard is, however, the sound at the position of the ear drum. The system in accordance with the invention enables a true to life reproduction of sound at the position of the microphone. Small discrepancies may nevertheless occur in regards of the sound at the eardrum. Using more than one microphone, thus making sure that at several positions close to the eardrum a true-to-life sound reproduction is achieved, reduces such discrepancies and thereby improves the system.

In the shown examples the sound reproduction means comprises headphones. This forms a preferred embodiment. However, the sound reproduction means may be other sound reproduction means for instance two loudspeakers in a car, also the number of sound reproduction means per ear or per system may vary.

Into the system further recording devices (e.g. for recording video) may be incorporated.

FIG. 6 illustrates schematically a computer readable medium (CD-Rom, cassette or other carrier) comprising a computer program code means or computer program product in accordance with the invention.

The invention is also embodied in a method for recording and reproduction of sound through ear microphones and sound reproduction means in which method

sound data are recorded by ear microphones

said sound data is stored on a storage device

said recorded sound data is reproduced during which reproduction the recorded

data is reproduced on sound reproduction means

said recorded sound data forming input data for a feed back system (25) comprising an input (24), an adaptive filter (21), at least an ear microphone (M_R, M_L), at least one sound reproduction means (LS_R, LS_L) and a comparison means (22) for comparing an input signal (S3) to a signal received by the microphone (S6) upon during reproduction of said input signal (S3), said comparison means (22) providing a comparison 25 signal (e) for regulating the adaptive filter (21).

The invention is further also embodied in A sound reproduction system comprising ear microphones and sound reproduction means for generating sound and means to control the sound signal generated by said sound reproduction means, characterized in the system comprises an input (24) for a recorded sound signal (S3) for a sound signal on the means for generating sound (LS_R, LS_L) through an adaptive filter (21), the system comprising a feed back system (25) comprising the input (24), the adaptive filter (21), at least an ear microphone (M_R, M_L), at least one sound reproduction means (LS_R, LS_L) and a comparison means (22) for comparing an input signal (S3) to a signal received by the microphone (S6) during reproduction of said input signal (S3), said comparison means (22) providing a comparison signal (e) for regulating the adaptive filter (21).

As stated above, the signal at the input (24) may be any signal, and the feed back system ensures that there is an equivalence between the input signal S3 and the signal S6. This is advantageous since a number of transfer functions which otherwise would have to be calculated with inherent inaccuracies are in the sound reproducing system automatically correct.

1. A sound recording and reproduction system comprising:
ear microphones for recording sound;
sound reproduction means for generating sound; and
means to control the sound signal generated by said sound reproduction means,
characterized in that the system comprises:
a storing device (2) for storing sound signals recorded by the microphones (M_R, M_L);
an input (24) for reproduction of a recorded sound signal (S3) on the means for generating sound (LS_R, LS_L) through an adaptive filter (21),
the system comprising a feed back system (25) comprising the input (24), the adaptive filter (21), at least one ear microphone (M_R, M_L), at least one sound reproduction means (LS_R, LS_L) and a comparison means (22) for comparing an input signal (S3) to a signal received (S6) by the microphone during reproduction of said input signal (S3), said comparison means (22) providing a comparison signal (e) for regulating the adaptive filter (21).

2. A sound recording and reproduction system as claimed in claim 1, characterized in that the sound reproduction means are headphones (LS_R, LS_L).

3. A sound recording and reproduction system as claimed in claim 1, characterized in that the system comprises a delay element (23) for delaying the recorded signal prior to the comparison means (22).

4. A sound recording and reproduction system as claimed in claim 1, characterized in that the system comprises a means (31) to alter a recorded signal prior to the input of the feed back system (25).

5. A sound recording and reproduction system as claimed in claim, characterized in that the system comprises head tracking means (51, 52, 53, 54).

6. Computer program comprising program code means for use in a system in accordance with the invention when said program is run on a computer.

7. Computer program product comprising program code means stored on a computer readable medium for use in a system in accordance with the invention when said program is run on a computer.

8. Computer readable medium (CD, cassette or other carrier) comprising a computer program code means or computer program product as claimed in claim 7.

9. Method for recording and reproduction of sound through ear microphones and sound reproduction means in which method
sound data are recorded by ear microphones
said sound data is stored on a storage device
said recorded sound data is reproduced during which reproduction the recorded data is reproduced by sound reproduction means
said recorded sound data forming input data for a feed back system (25) comprising an input (24), an adaptive filter (21), at least an ear microphone (M_R, M_L), at least one sound reproduction means (LS_R, LS_L) and
the input data (S3) are compared in a comparison means (22) to a signal received by the microphone (S6) during reproduction of said input data (S3)
and by said comparison means (22) a comparison signal (e) for regulating the adaptive filter (21) is provided.

10. Computer program product comprising program code means stored on a computer readable medium for use in a method in accordance with the invention when said program is run on a computer.

11. Computer readable medium (CD, cassette or other carrier) comprising a computer program code means or computer program product as claimed in claim 10.

12. A sound reproduction system comprising ear microphones and sound reproduction means for generating sound and means to control the sound signal generated by said sound reproduction means, characterized in that the system comprises an input (24) for a recorded sound signal (S3) on the means for generating sound (LS_R, LS_L) through an adaptive filter (21), the system comprising a feed back system (25) comprising the input (24), the adaptive filter (21), at least one ear microphone (M_R, M_L), at least one sound reproduction means (LS_R, LS_L) and a comparison means (22) for comparing an input signal (S3) to a signal received by the microphone (S6) during reproduction of said input signal (S3), said comparison means (22) providing a comparison signal (e) for regulating the adaptive filter (21).
